(19) United States
(12) Patent Application Publication
(10) Pub. No.: US 2026/0259588 A1
(43) Pub. Date: Sep. 3, 2026

(54) ELECTRIC POWER CONSUMPTION MANAGEMENT DEVICE, PROGRAM AND ELECTRIC POWER CONSUMPTION MANAGEMENT METHOD

(71) Applicant: NTT, Inc., Tokyo (JP)

(72) Inventors: Katsumi FUJITA, Musashino-shi, Tokyo (JP); Eriko IWASA, Musashino-shi, Tokyo (JP); Masashi KANEKO, Musashino-shi, Tokyo (JP)

(21) Appl. No.: 18/718,490

(22) PCT Filed: Dec. 21, 2021
(86) PCT No.: PCT/JP2021/047357

§ 371 Date: Jun. 11, 2024

(51) Int. Cl. G06F 1/26

(52) U.S. Cl. CPC G06F 1/26

(57) ABSTRACT

A power consumption management device includes: a collection unit that collects performance information and power consumption of servers, and; and a selection unit that selects items of the performance information serving as candidates for explanatory variables in a power consumption estimation model in which items of the performance information are used as the explanatory variables and the power consumption is used as an objective variable. The selection unit is characterized by excluding items whose value changes are equal to or less than a predetermined value among the items of the performance information and further excluding the items using a multivariate analysis method to select the items.

### TECHNICAL FIELD

The present invention relates to a power consumption management device, a program, and a power consumption management method for managing power consumption of servers installed in a data center or the like.

### BACKGROUND ART

With the expansion of fields of computer use and the spread of network services, power consumption of a server group that provides services is increasing. Reduction of power consumption is required not only from the viewpoint of cost but also from the viewpoint of climate change risk. So far, as known measures and methods for reducing power consumption, there are system aggregation using virtualization technology and reduction of power consumption of a central processing unit (CPU) by dynamic voltage and frequency scaling (DVFS). These are methods of monitoring or estimating power consumption of a server and then controlling hardware and software of the server to reduce the power consumption.

Examples of main methods for monitoring power consumption of a server include a physical measurement method and a method of performing estimation from server performance information. Although examples of the physical measurement method include a technique using a power meter, this technique requires installation costs and a server needs to be stopped at the time of installation, which is not suitable for monitoring a large number of servers at once. In addition, there is a method of acquiring power consumption from a power sensor equipped in a server via an intelligent platform management interface (IPMI). However, not all servers are equipped with power sensors, and measurement accuracy depends on device types.

In the case of estimating power consumption from server performance information, the performance information is acquired from hardware or an OS, and the power consumption is estimated from acquired performance values. In the technique described in NPL 1, power consumption is estimated on the basis of performance information of two levels including a software level and a hardware level. Further, in the technique of NPL 2, power consumption is estimated on the basis of 158 performance information.

### CITATION LIST

### Non Patent Literature

[NPL 1] Eva Garcia-Martin, et al., “Estimation of energy consumption in machine learning,” Journal of Parallel and Distributed Computing, 134 (2019), pp. 75-88.

[NPL 2] Ziyu Shen, et al., “PCP-2LSTM: Two Stacked LSTM-based Prediction Model for Power Consumption in Data Centers,” 2019 Seventh International Conference on Advanced Cloud and Big Data (CBD), pp. 13-18.

### SUMMARY OF INVENTION

### Technical Problem

By using server performance information, it is possible to estimate power consumption while inhibiting dependency of a server on device types. However, collecting performance information itself also increases power consumption. In experiments conducted by the present inventors, power consumption increases by about 6% by collecting server performance, which cannot be ignored in a large-scale data center with a large number of servers. In addition, in the case of collecting performance information not only for estimating power consumption but also for managing servers, it is desirable to collect the performance information in consideration of the power consumption.

The present invention has been made in view of such a background, and an object thereof is to enable reduction of power consumption required for collecting performance information used for estimating server power consumption.

### Solution to Problem

In order to solve the above problems, provided is a power consumption management device according to the present invention including: a collection unit configured to collect server performance information and power consumption; and a selection unit configured to select items of the performance information serving as candidates for explanatory variables in a power consumption estimation model in which items of the performance information are used as the explanatory variables and the power consumption is used as an objective variable, wherein the selection unit excludes the items whose value changes are less than or equal to a predetermined value among the items of the performance information and further excludes the items using a multivariate analysis method to select the items.

### Advantageous Effects of Invention

According to the present invention, it is possible to enable reduction of power consumption required for collecting performance information used for estimating server power consumption.

### BRIEF DESCRIPTION OF DRAWINGS

FIG. 1 is a functional block diagram of a power consumption management device according to the present embodiment.

FIG. 2 is a flowchart of model generation processing of a power consumption estimation model according to the present embodiment.

FIG. 3 is a flowchart of parameter selection processing according to the present embodiment.

FIG. 4 is a flowchart of power consumption management processing according to the present embodiment.

FIG. 5 is a hardware configuration diagram showing an example of a computer that implements functions of the power consumption management device according to the present embodiment.

### DESCRIPTION OF EMBODIMENTS

A power consumption management device according to an aspect (embodiment) for implementing the present invention will be described below. The power consumption management device estimates power consumption of a server (physical server) by using a power consumption estimation model which is a model of machine learning and function approximation (regression) on the basis of performance information of the server.

Explanatory variables (inputs) of the power consumption estimation model include those related to hardware operations such as the number of branch prediction misses and the number of cache misses, and those related to an OS such as a CPU usage rate and a memory usage rate.

The power consumption management device according to the present embodiment excludes parameters that are always constant values among the items of the performance information (performance information items, or the parameters) and further reduces them using a multivariate analysis method. Examples of the multivariate analysis method include, for example, a method of deleting one of a pair of parameters having a partial correlation coefficient equal to or greater than a predetermined value or a method of reducing parameters by a stepwise method. Also, in the present embodiment, the fact that the performance information items (parameters) are constant values means that a time-series change in a parameter value is less than or equal to a predetermined value.

The power consumption management device generates the power consumption estimation model with some or all of the reduced performance information items (parameters) serving as the explanatory variables and the power consumption serving as an objective variable. The power consumption management device collects the performance information of the server, estimates the power consumption by using the power consumption estimation model, and controls the server to reduce the power consumption.

Since the power consumption required for collecting the performance information depends on the number of items (the number of parameters) of the performance information, it is desirable that the number of items be small. The power consumption management device uses performance information items that have a strong relationship with the objective variable as explanatory variable candidates. For example, the power consumption management device uses items excluding the items whose values are constant (changes are small), or items remaining after excluding one of a pair of highly correlated items as the explanatory variable candidates. Further, the power consumption management device uses items having higher evaluation indexes than other items, which will be described later, as the explanatory variable candidates. Subsequently, the power consumption management device generates the power consumption estimation model with some or all of the explanatory variable candidates as the explanatory variables. As a result, the power consumption management device can perform prediction of the power consumption with high accuracy while reducing the number of items collected and reducing the power consumption required for the collection. The power consumption management device can perform appropriate control of the server on the basis of the predicted power consumption to perform management for reducing the power consumption.

### Configuration of Power Consumption Management Device

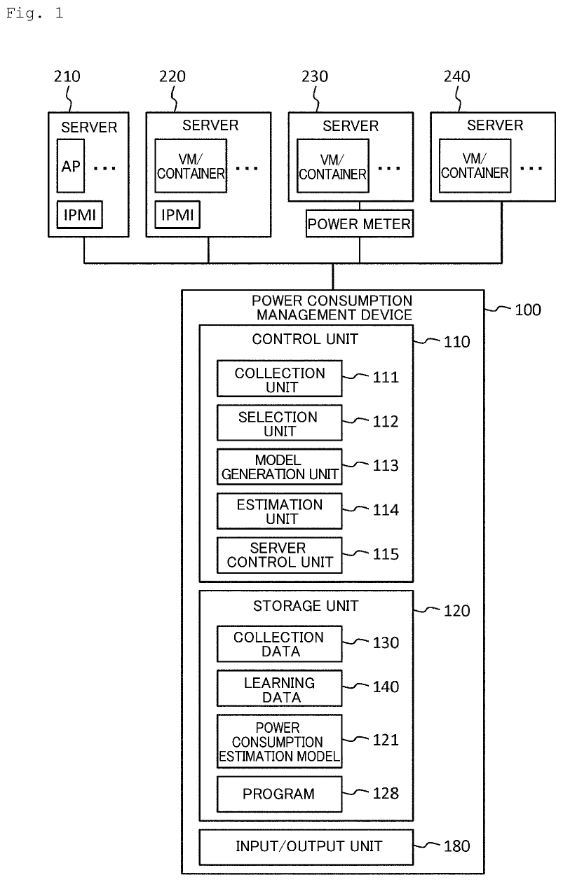

FIG. 1 is a functional block diagram of a power consumption management device 100 according to the present embodiment. The power consumption management device 100 collects performance information from a server 210 on which an application is operated, and servers 220 and 230 on which virtual machines (referred to as VMs in FIG. 1) or containers are operated. The performance information includes performance information items related to operations of hardware such as the number of branch prediction misses and the number of cache misses, and performance information items related to an OS such as a CPU usage rate and a memory usage rate. In addition, the power consumption management device 100 collects power consumption of the servers 210, 220, and 230 from an IPMI provided in the servers 210 and 220 and a power meter connected to the server 230.

In FIG. 1, the power consumption of the server 210, 220, and 230 can be collected using the IPMI, a power meter, or the like, but after a power consumption estimation model 121, which will be described later, is generated, collection of the power consumption is not required. For example, if a power consumption estimation model 121 of a certain server is generated, power consumption can be estimated from performance information by using the same power consumption estimation model 121 for other servers having the same device type, the same configuration, and the same type of application operated, and the IPMI and a power meter are not required. For example, in FIG. 1, a server 240 is of the same device type as the server 230, and power consumption can be estimated from performance information by using the power consumption estimation model 121 of the server 230.

The power consumption management device 100 is a computer and includes a control unit 110, a storage unit 120, and an input and output unit 180. User interface devices such as a display, a keyboard, and a mouse are connected to the input and output unit 180. The input and output unit 180 includes a communication device and can transmit and receive data to and from the servers 210, 220, 230, and 240. Also, a media drive may be connected to the input and output unit 180, and data can be exchanged using a recording medium.

### Power Consumption Management Device: Storage Unit

The storage unit 120 is configured to include storage devices such as a read only memory (ROM), a random access memory (RAM), a solid state drive (SSD), and the like. The storage unit 120 stores collection data 130, learning data 140, the power consumption estimation model 121, and a program 128. The collection data 130 is performance information (values of performance information items (parameters) ) and the power consumption that are collected from the servers 210, 220, and 230. The collection data 130 is time-series data collected at predetermined timings, for example, periodically.

The learning data 140 is learning data used when the power consumption estimation model 121, which will be described later, is generated. Explanatory variables of the learning data 140 are the performance information, and an objective variable is the power consumption. The learning data 140 may be configured of data of the performance information items (parameters) serving as the explanatory variables of the power consumption estimation model 121 and the power consumption in the collection data 130. These parameters are further subjected to preprocessing (selection of the parameters serving as the explanatory variables) optimal for each device type of a server serving as a control target and applications (services) on the server, and the performance information corresponding to the selected parameters and power consumption may be used as the learning data 140. Also, it may be configured by newly collecting data of the explanatory variables and the power consumption separately from the collection data 130.

The power consumption estimation model 121 is a model of a machine learning technique or function approximation (regression) and uses the performance information as the explanatory variables (inputs) and the power consumption as the objective variable (output).

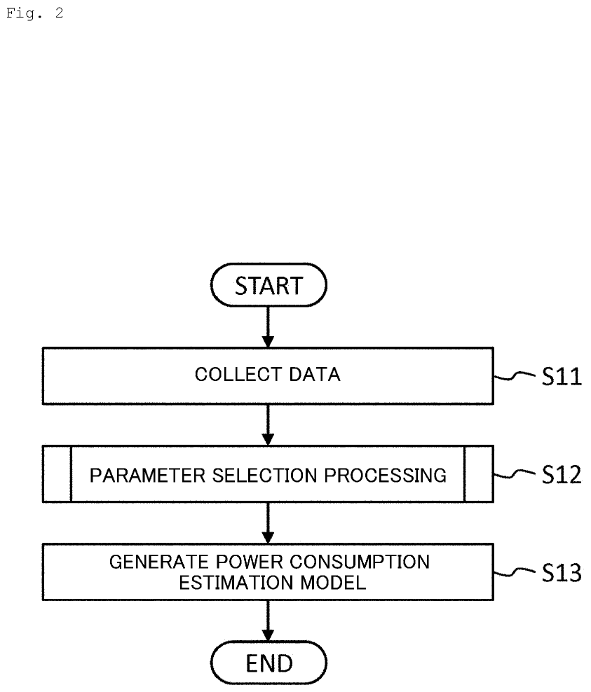

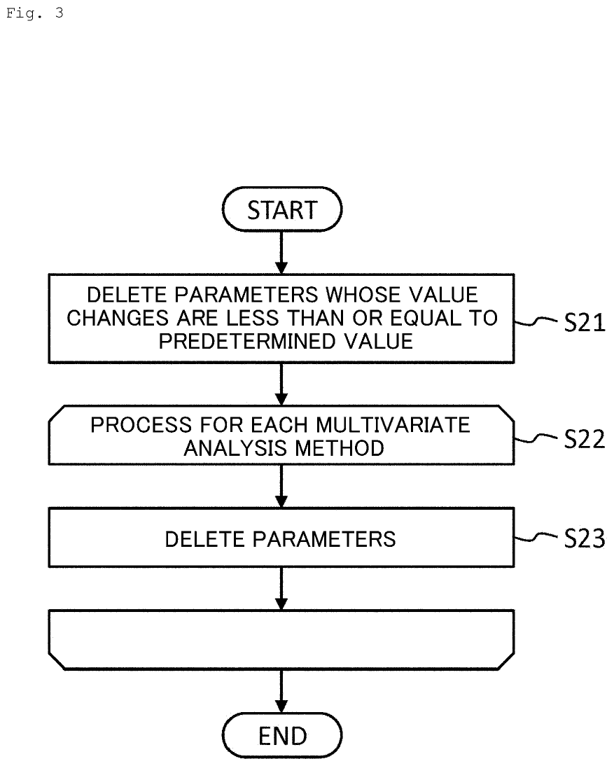

The program 128 includes description of model generation processing (see FIG. 2) and parameter selection processing (see FIG. 3), which will be described later.

### Power Consumption Management Device: Control Unit

The control unit 110 is configured to include a CPU, in which a collection unit 111, a selection unit 112, a model generation unit 113, an estimation unit 114, and a server control unit 115 are included.

The collection unit 111 collects the performance information (parameter values) and the power consumption from the servers 210, 220, and 230 and stores them as the collection data 130. Also, collection of the power consumption by the collection unit 111 is performed in the case of preparing the learning data 140 to generate the power consumption estimation model 121. After the generation of the power consumption estimation model 121, the collection unit 111 does not collect the power consumption of the servers 210, 220, and 230 except, for example, in the case of updating the power consumption estimation model 121, in the case of generating the power consumption estimation model 121 of the servers 210, 220, and 230 formed by new device types or new configurations. Also, the collection unit 111 collects the performance information serving as the explanatory variables of the power consumption estimation model 121 after the generation of the power consumption estimation model 121 and does not collect other performance information.

The selection unit 112 selects candidates of the parameters (the explanatory variables of the power consumption estimation model 121) used for predicting the power consumption from among the performance information items (parameters). The selection unit 112 deletes parameters of which changes in the collected performance information (parameter values) are less than or equal to a predetermined value. Also, the selection unit 112 calculates a partial correlation coefficient between two parameters, and when a P value (significance probability) of a non-correlation test is less than or equal to a predetermined value (for example, 0.05) and the partial correlation coefficient is equal to or greater than a predetermined value (for example, 0.5), deletes one parameter.

In addition, the selection unit 112 applies a stepwise method with the performance information set as the explanatory variables and the power consumption set as the objective variable for the remaining parameters, leaves parameters whose P value is less than or equal to a predetermined value (for example, 0.05) among the obtained partial regression coefficients while deleting others, thereby selecting candidates of the parameters used for the prediction. The remaining parameters are parameters from which parameters whose change in parameter value is less than or equal to a predetermined value have been excluded, or parameters from which one of a pair of parameters whose partial correlation coefficient is equal to or greater than a predetermined value have been further excluded.

For example, the selection unit 112 selects candidates of the parameters used for the prediction using a variable increasing and decreasing method or a variable decreasing and increasing method in stepwise method for the remaining parameters. Also, for example, the selection unit 112 may delete parameters one by one by repeating processing of deleting one parameter by selecting the one parameter from the remaining parameters and deleting this selected parameter so that an evaluation index of the remaining parameter group is maximized. The evaluation index of the parameter group is an index on the basis of an information amount criterion of a model using the parameter group as the explanatory variables, and a model having a greater evaluation index among a plurality of models is a desirable model. Examples of the information amount criterion include Akaike's information criterion (AIC) and Bayesian information criterion (BIC).

The model generation unit 113 selects the explanatory variables from the parameters selected by the selection unit 112 and generates the power consumption estimation model 121 using the learning data 140. The explanatory variables of the power consumption estimation model 121 is a parameter group included in the parameters (parameter group) selected by the selection unit 112, and the parameter group is selected in accordance with a device type of a server and/or applications (services) on the server. In addition, the parameter group is selected so estimation accuracy is improved. For example, the model generation unit 113 may calculate the power consumption using a plurality of power consumption estimation models 121 generated in preprocessing of model generation and adopt the power consumption estimation model 121 having the highest accuracy. Also, the model generation unit 113 may generate the power consumption estimation model 121 using all the parameters selected by the selection unit 112 as the explanatory variables.

Examples of a method for the model generation unit 113 to generate the power consumption estimation model 121 by selecting the parameter group in accordance with the device type of the server or the applications include a method of generating a power consumption estimation model 121 by selecting parameters having a correlation (for example, a correlation coefficient is 0.5 or more) with power consumption of a server in accordance with a device type of the server and applications operated thereon and using them as explanatory variables, thereby generating the power consumption estimation model 121. In addition, there is a method of performing dimension reduction (parameter reduction) by performing principal component analysis to generate estimation models for a plurality of machine learning algorithms and using an estimation model with the highest estimation accuracy as the power consumption estimation model 121. Alternatively, a stepwise method may be used to reduce the parameters, or these methods may be combined.

Further, examples of the applications include a Web application, a database server, an application having a high CPU load, and an application having a large amount of inputs and outputs (the number of times). In addition, examples of the server include a server in which a specific type of application is operated among the above types, and a server in which various types of applications are operated. The model generation unit 113 selects the parameter group in accordance with a device type of the server and a type of the application operated and generates the power consumption estimation model 121.

For the learning data 140 used for learning (generation) of the power consumption estimation model 121, performance information corresponding to parameters after preprocessing of selecting (reducing) the parameters in accordance with the device type of the server serving as the control target or the application on the server from the parameters selected by the selection unit 112, which is performed by the model generation unit 113, may be used. The learning data 140 may be configured of the collection data 130 or may be newly collected and configured.

The estimation unit 114 calculates (estimates) the power consumption from the performance information using the power consumption estimation model 121. Also, the performance information is performance information serving as the explanatory variables of the power consumption estimation model 121 and is performance information collected by the servers 210, 220, 230 and 240.

The server control unit 115 controls the servers on the basis of the estimated power consumption. For example, when the virtual machines or the containers are operated and there are a plurality of servers whose power consumption is less than or equal to a predetermined power consumption, the server control unit 115 consolidates the virtual machines or the containers into one server and stops the server of a movement source to reduce the power consumption. Also, for example, when the power consumption is equal to or greater than a predetermined value, the server control unit 115 may reduce a clock rate of the CPU of the server. Alternatively, the server control unit 115 may adjust the number of operating power supply modules in accordance with the power consumption of the server group.

### Model Generation Processing

FIG. 2 is a flowchart of the model generation processing of the power consumption estimation model 121 according to the present embodiment. The power consumption estimation model 121 may be generated only once in accordance with the servers of the same device type or the same configuration and types of the applications operated on the servers, or may be updated at a predetermined timing (for example, periodically).

In step S11, the collection unit 111 collects the performance information and the power consumption of the servers 210, 220, and 230 and stores them in the collection data 130.

In step S12, the selection unit 112 executes the parameter selection processing (see FIG. 3, which will be described later) to select performance information items (parameters) serving as candidates for the explanatory variables of the power consumption estimation model 121.

In step S13, the model generation unit 113 generates the power consumption estimation model 121. The explanatory variables of the power consumption estimation model 121 are selected from the parameters selected in the parameter selection processing of the step S12 in accordance with the device types of the server serving as the control target and the application on the server. The learning data 140 used for learning the power consumption estimation model 121 may be configured by extracting the performance information and the power consumption corresponding to the explanatory variables of the power consumption estimation model 121 from the collection data 130 collected in step S11, or may be configured by newly collecting the performance information and the power consumption.

### Parameter Selection Processing

FIG. 3 is a flowchart (see step S12 in FIG. 2) of the parameter selection processing according to the present embodiment.

In step S21, the selection unit 112 deletes performance information items (parameter) whose values do not change or whose value changes are less than or equal to a predetermined value from the performance information collected in step S11 (see FIG. 2).

In step S22, the selection unit 112 starts processing for executing step S23 for each multivariate analysis method.

In step S23, the selection unit 112 deletes parameters in accordance with the multivariate analysis method. For example, in a multivariate analysis method using a partial correlation coefficient, the selection unit 112 calculates a partial correlation coefficient between two parameters, and in a case in which a P value of a non-correlation test is less than or equal to a predetermined value (for example, 0.05) and the partial correlation coefficient is equal to or greater than a predetermined value (for example, 0.5), deletes one parameter. Also, in a multivariate analysis method using a stepwise method, the selection unit 112 applies the stepwise method using the performance information as the explanatory variables and the power consumption as the objective variable, leaves parameters having a P value of the obtained partial regression coefficient is less than or equal to a predetermined value (for example, 0.05), and deletes others. The selection unit 112 may further delete parameters using other multivariate analysis methods (for example, principal component analysis and multiple regression analysis).

### Power Consumption Management Processing

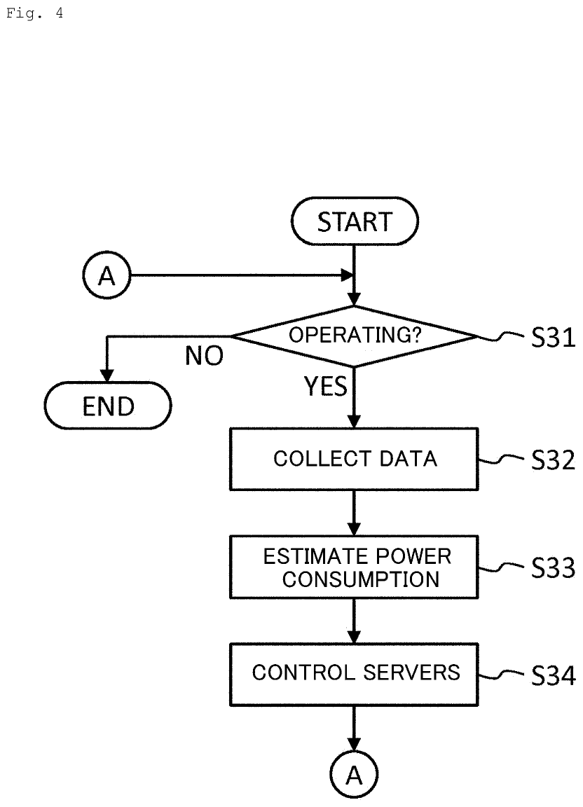

FIG. 4 is a flowchart of power consumption management processing according to the present embodiment. In the power consumption management processing, steps S32 to S34 are repeatedly executed while the servers are in operation. In step S31, if any of the servers 210, 220, 230, and 240 is in operation (step S31-YES), the collection unit 111 proceeds to step S32, and if stopped (step S31-NO), ends the power consumption management processing.

In step S32, the collection unit 111 collects performance information from servers 210, 220, 230, and 240. This performance information is performance information of parameters serving as the explanatory variables of the power consumption estimation model 121.

In step S33, the estimation unit 114 calculates (estimates) the power consumption using the power consumption estimation model 121 on the basis of the performance information collected in step S32.

In step S34, the server control unit 115 controls servers 210, 220, 230, and 240 on the basis of the power consumption estimated in step S33.

### Characteristics of Power Consumption Management Device

The power consumption management device 100 selects candidates of the explanatory variables of the power consumption estimation model 121 when the power consumption estimation model 121 for estimating the power consumption from the performance information of the servers is generated. In the selection, the power consumption management device 100 excludes the parameters whose value changes are less than or equal to a predetermined value from the collectable performance information. Next, the power consumption management device 100 excludes one of parameter pairs whose partial correlation coefficient is greater than a predetermined value, and further excludes the parameters using a stepwise method. Subsequently, the power consumption management device 100 may generate the power consumption estimation model 121 using all the parameters selected by the selection unit 112 as the explanatory variables, or the model generation unit 113 may perform preprocessing for parameter reduction (explanatory variable selection) in accordance with the device type of the server serving as the control target and the application (service) on the server to generate the power consumption estimation model 121 using the reduced parameters as the explanatory variables.

Examples of the parameters whose values do not change (value changes are less than or equal to a predetermined value) and which are deleted in step S21 include alignment-faults (the number of accesses to unaligned data), swap-used/swap-free (a used size/a free size of a swap area), and the like. Examples of the parameters whose partial correlation coefficient is equal to or greater than a predetermined value and which are deleted in step S23 include page-faults (the number of page faults), file_locks_wri (the number of file locks at the time of writing), and the like. Further, examples of the parameters deleted in step S23 by the stepwise method include LLC-prefetches (the number of prefetches from a main memory to the Last Level Cache), memory-usage-cach (a cache size of a memory), and the like.

According to experiments conducted by the present inventors, among 146 parameters preset as the performance information, 34 parameters were deleted by deleting the parameters whose value changes are less than or equal to a predetermined value and calculating the partial correlation coefficient to further delete parameters. Further, 60 parameters were deleted using the stepwise method, and 52 parameters were selected. That is, 94 parameters could be deleted from 146 parameters. Examples of the finally selected parameters include branch-loads (the number of reads of a branch prediction unit), LLC-loads (the number of LLC reads), context-switches (the number of context switches), a CPU usage rate, a memory usage rate, the number of writes, and the like.

The power consumption management device 100 can estimate the power consumption with high accuracy from the performance information of a small number of parameters. Since the number of performance information items to be collected is small, the power consumption management device 100 can reduce the power consumption of the server required for the collection.

Further, the power consumption management device 100 controls the server to reduce the power consumption on the basis of the estimated power consumption. As a result, the power consumption management device 100 can efficiently reduce the power consumption.

### Modified Examples: Multivariate Analysis Method

In the above-described embodiments, for the multivariate analysis methods, the method of calculating partial correlation coefficients of parameter pairs and the stepwise method are used, but either one may be used. For example, by further excluding parameters using the stepwise method from remaining parameters after excluding the parameters whose value changes are less than or equal to the predetermined value, the remaining parameters may be used as the candidates for the explanatory variables of the power consumption estimation model 121. Also, in the case of using the stepwise method, in order to avoid multicollinearity, it is desirable to use the stepwise method after calculating the partial correlation coefficient and excluding the parameters with high correlation.

### Modified Examples: Applications Other Than Power Consumption Estimation

In the above-described embodiment, the power consumption management device 100 collects the performance information of some or all of the parameters selected in the parameter selection processing (see FIG. 3) to estimate the power consumption and controls the servers to reduce the power consumption of the servers.

The collected performance information may be used for other purposes. For example, it may be used for performance monitoring of a server or an application operated on the server. In a case in which the selected parameters are insufficient after monitoring the performance, additional parameters may be collected. By monitoring the performance on the basis of the parameters selected in the parameter selection processing, it is possible to perform the performance monitoring while inhibiting the power consumption.

### Other Modified Examples

In the above-described embodiments, the power consumption management device 100 generates the power consumption estimation model 121, estimates the power consumption using the model, and controls the servers. The generation of the power consumption estimation model 121, the estimation of power consumption, and the control of the servers may be executed by different devices. For example, the power consumption may be estimated on the basis of the performance information collected by a server management device using the power consumption estimation model 121 generated by the power consumption estimation model generation device to control the servers. Further, a collection unit included in the server management device collects performance information of the performance information items serving as the explanatory variables of the power consumption estimation model 121 from the servers.

Although several embodiments of the present invention have been described above, these embodiments are merely examples and do not limit the technical scope of the present invention. The present invention can take various other embodiments, and various modifications such as omissions and substitutions can be made without departing from the gist of the present invention. These embodiments and modifications thereof are included in the scope or gist of the invention described in the present specification and the like and are also included in the scope of the invention described in the claims and the equivalent scope thereof.

### Hardware Configuration

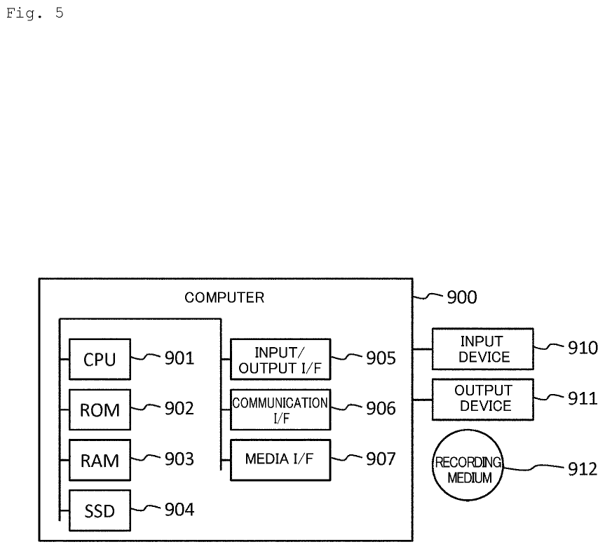

The power consumption management device 100 according to the present embodiment is realized by, for example, a computer 900 having a configuration as shown in FIG. 5. FIG. 5 is a hardware configuration diagram showing an example of the computer 900 that implements the functions of the power consumption management device 100 according to the present embodiment. The computer 900 includes a CPU 901, a ROM 902, a RAM 903, a solid state drive (SSD) 904 (described as an SSD in FIG. 5), an input and output interface (I/F) 905 (described as an input/output I/F in FIG. 5), a communication interface (I/F) 906 (described as a communication I/F in FIG. 5), and a media interface (I/F) 907 (described as a media I/F in FIG. 5). The computer 900 may include a hard disk instead of the SSD 904, or may include a hard disk in addition to the SSD 904.

The CPU 901 operates on the basis of a program stored in the ROM 902 or the SSD 904 and performs control by the control unit 110 in FIG. 1. The ROM 902 stores a boot program executed by the CPU 901 when the computer 900 is started, a program related to hardware of the computer 900, and the like. The CPU 901 controls an input device 910 such as a mouse or a keyboard and an output device 911 such as a display or a printer via the input and output interface 905. The CPU 901 acquires data from the input device 910 and outputs generated data to the output device 911 via the input and output interface 905.

The SSD 904 stores programs executed by the CPU 901, data used by the programs, and the like. The communication interface 906 receives data from other devices (for example, the servers 210, 220, and 230, or the like) via a communication network, outputs the data to the CPU 901, and transmits data generated by the CPU 901 to the servers 210, 220, and 230 via a communication network.

The media interface 907 reads a program or data stored in a recording medium 912 and outputs the read program or data to the CPU 901 via the RAM 903. The CPU 901 loads the program from the recording medium 912 on the RAM 903 via the media interface 907 and executes the loaded program. The recording medium 912 is an optical recording medium such as a Blu-ray Disc (BD) (registered trademark), a magneto-optical recording medium such as a magneto optical disk (MO), a magnetic recording medium, a conductor memory tape medium, a semiconductor memory, or the like.

For example, in a case in which the computer 900 serves as the power consumption management device 100 according to the present embodiment, the CPU 901 of the computer 900 implements the functions of the power consumption management device 100 by executing the program 128 (see FIG. 1) loaded on the RAM 903. The CPU 901 reads the program from the recording medium 912 and executes the program. In addition, the CPU 901 may read a program from another device via a communication network or may install the program 128 from the recording medium 912 to the SSD 904 and execute the program.

### Effects

Effects of the power consumption management device 100 will be described below. The power consumption management device 100 according to the present embodiment includes: the collection unit 111 that collects the performance information and the power consumption of the servers; and the selection unit 112 that selects the items of the performance information serving as the candidates of the explanatory variables in the power consumption estimation model 121 in which the items of the performance information are used as the explanatory variables and the power consumption is used as the objective variable. The selection unit 112 excludes the items whose value changes are less than or equal to the predetermined value among the items of the performance information and further excluding the items using the multivariate analysis method to select the items.

According to such a power consumption management device 100, for the explanatory variables of the power consumption estimation model 121, it is possible to select the explanatory variables that have a small number of items and a strong relationship (a high evaluation index) with the power consumption serving as the objective variable. By collecting the performance information serving as the input when the power consumption is estimated with low power consumption, it is possible to specify the explanatory variables (the performance information items or the parameters) that can be estimated with high accuracy.

The multivariate analysis method according to the present embodiment is the method for calculating a partial correlation coefficient of an item pair, and when the partial correlation coefficient of the item pair are equal to or greater than the predetermined value, the selection unit 112 excludes one of the items.

According to such a power consumption management device 100, the explanatory variables can be reduced using the partial correlation coefficient.

The multivariate analysis method according to the present embodiment is the stepwise method, and the selection unit 112 further selects items using the stepwise method in which the selected items are used as the explanatory variables and the power consumption is used as the objective variable.

According to such a power consumption management device 100, it is possible to reduce the explanatory variables by leaving the explanatory variables that are strongly related to the objective variable (having a high evaluation index) using the stepwise method.

The power consumption management device 100 according to the present embodiment further includes the model generation unit 113 that generates the power consumption estimation model 121 in which the items selected by the selection unit 112 from the performance information and the power consumption collected by the collection unit 111, or the items further reduced from the selected items in accordance with the device types of the servers and/or services on the servers are used as the explanatory variables, and the power consumption is used as the objective variable.

According to such a power consumption management device 100, the power consumption estimation model 121 is generated in which the items selected by the selection unit 112 are used as the explanatory variables and the power consumption is used as the objective variable. The number of items of the performance information serving as the input to the power consumption estimation model 121 is small, the collection can be made with low power consumption, and the estimation can be made with high accuracy.

The collection unit 111 according to the present embodiment collects only performance information serving as the explanatory variables of the power consumption estimation model 121 after the power consumption estimation model 121 is generated, and the estimation unit 114 that estimates the power consumption of the servers using the power consumption estimation model 121 on the basis of the collected performance information is further provided.

According to such a power consumption management device 100, the performance information can be collected with low power consumption, and the power consumption can be estimated with high accuracy.

### REFERENCE SIGNS LIST

100 Power consumption management device
111 Collection unit
112 Selection unit
113 Model generation unit
114 Estimation unit
115 Server control unit
121 Power consumption estimation model
128 Program
130 Collection data
140 Learning data
210, 220, 230, 240 Server

1. A power consumption management device comprising one or more processors configured to perform operations comprising:
collecting performance information and power consumption of a server; and
selecting items of the performance information serving as candidates for explanatory variables in a power consumption estimation model in which items of the performance information are used as the explanatory variables and the power consumption is used as an objective variable,
wherein the selecting excludes the items whose value changes are less than or equal to a predetermined value among the items of the performance information and further excludes the items using a multivariate analysis method to select the items.

2. The power consumption management device according to claim 1, wherein the one or more processors are configured to perform the multivariate analysis method to calculate a partial correlation coefficient of an item pair, and the selecting excludes one of the item pair when the partial correlation coefficient of the item pair is equal to or greater than a predetermined value.

3. The power consumption management device according to claim 1, wherein the multivariate analysis method is a stepwise method, and the selecting includes selecting the items using the stepwise method with the selected and remaining items as the explanatory variables and the power consumption as the objective variable.

4. The power consumption management device according to claim 1, wherein the operations further comprise generating the power consumption estimation model, wherein, in the model, the items selected and the power consumption collected, or the items further reduced from the selected items in accordance with a device type of the server or a service on the server are used as the explanatory variables, and the power consumption is used as the objective variable.

5. The power consumption management device according to claim 4, wherein the collecting comprises collecting only the performance information serving as the explanatory variables of the power consumption estimation model after the power consumption estimation model is generated, and the operations further comprise estimating the power consumption of the server using the power consumption estimation model on the basis of the collected performance information.

6. (canceled)

7. A power consumption management method comprising:
collecting performance information and power consumption of a server; and
selecting items of the performance information serving as candidates for explanatory variables in a power consumption estimation model in which items of the performance information are used as the explanatory variables and the power consumption is used as an objective variable,
wherein selecting the items of the performance information includes excluding the items whose value changes are less than or equal to a predetermined value among the items of the performance information and further excluding the items using a multivariate analysis method to select the items.

8. A non-transitory computer-readable medium storing instructions which, upon execution, cause one or more processors to perform operations comprising:
collecting performance information and power consumption of a server; and
selecting items of the performance information serving as candidates for explanatory variables in a power consumption estimation model in which items of the performance information are used as the explanatory variables and the power consumption is used as an objective variable,
wherein the selecting excludes excluding the items whose value changes are less than or equal to a predetermined value among the items of the performance information and further excludes the items using a multivariate analysis method to select the items.
